(19) United States
(12) Patent Application Publication
(10) Pub. No.: US 2007/0181601 A1
(43) Pub. Date: Aug. 9, 2007

(54) Storage and Dispensing System for Potable Liquids

(76) Inventor: Geoff Daly, Holland, MI (US)

Correspondence Address: CERMAK & KENEALY LLP, 515 E. BRADDOCK RD, SUITE B, ALEXANDRIA, VA, 22314, US

(21) Appl. No.: 11/672,317

(22) Filed: Feb. 7, 2007

Related U.S. Application Data
(60) Provisional application No. 60/743,242, filed on Feb. 7, 2006.

(51) Int. Cl. B67D 1/08; B65D 83/00

(52) U.S. Cl. 222/152; 222/399; 222/129; 222/185.1

(57) ABSTRACT

A storage and dispensing system for potable liquids, e.g., wine, includes an inclined rack which holds a bottle with the neck down, a dispensing head sealing the bottle neck, and an inert gas supply system in fluid communication with the head. As liquid is dispensed from the bottle, low-pressure gas is admitted into the bottle, to inhibit oxidation of the wine. The system includes one or more self-sealing elements in the head itself and/or in gas lines between the head and a gas regulator. Because the self-sealing elements prevent air from entering into the system when the gas lines are detached, each bottle can have a dedicated head and bottles can be swapped out for dispensing, without the need for replacing bottle heads, sparging, or using more than one source of gas.

This application claims priority under 35 U.S.C. § 119 to U.S. provisional application No. 60/743,242, filed 7 Feb. 2006, the entirety of which is incorporated by reference herein.

### BACKGROUND

1. Field of Endeavor

The present invention relates to devices, systems, and processes useful for dispensing potable liquids, and more specifically to dispensing potable liquids from small containers with gravity.

2. Brief Description of the Related Art

Many potable liquids significantly oxidize upon exposure to air. While in some cases this may be advantageous, oxidation of many such liquids makes the drink less palatable, and is therefore to be avoided. For example, fruit wines, especially grape wines, are known to oxidize significantly once exposed to unlimited amounts of oxygen, such as when the closure (cork, screw top, and the like) is removed from a typical 750 ml wine bottle. While it is known that a small amount of oxygen is transported through a natural cork bottle closure, resulting in a very slow exposure of the wine to oxygen, more hermetic closures, such as screw tops, permit essentially no oxygen to contact the wine. Once the bottle is opened, however, oxidation of the wine (or, more accurately, of components of the wine) commences.

In the past there have been several ways proposed to deal with the inevitable degradation of the perceived quality of wine once a bottle has been opened. Of course, consuming the entire contents of the bottle before it is unpalatable is one course of action; other, more temperate measures have also been proposed. Devices have been proposed which permit a partial vacuum to be formed in the partially emptied wine bottle, with a replacement closure sealing the bottle neck; while removing some of the air from the bottle, air is still present in the bottle, however, and thus oxidation continues.

It has also been prevalent to inject an inert, non-oxygen-containing, food-grade gas into the opened, partially full bottle. The inert gas effectively takes the place of the air (sparges) in the bottle. At the same time, prior systems have typically relied on the pressure of the inert gas to dispense the wine from an upright bottle, thus requiring a dip tube extending to the bottom of the bottle. While useful in some environments, such systems require: large gas cylinders; the bottles to remain upright so that the dip tubes are guaranteed to be positioned in wine; the high pressures required for dispensing can be damaging to the wine; the required high pressures are difficult to maintain in the bottle, thus requiring very robustly attached closures. Such systems are therefore not suitable for home use.

There remains a need, therefore, for improvements in systems, devices, and methods which address these and other shortcomings in the prior art.

### SUMMARY

According to a first aspect of the invention, a wave washer comprises a disk, an opening in the disk, a lever extending from the disk, and undulations formed in the disk.

According to another aspect of the present invention, a bottle head comprises a valve having a valve stem, a fluid passage, and a dispensing port in fluid communication with the fluid passage, a seal portion extending from said valve, the fluid passage passing through the seal portion, at least one seal positioned around the seal portion, a movable element on the seal portion and adjacent to the at the least one seal, and at least one wave washer positioned on said seal portion between said movable element and said valve.

According to yet another aspect of the present invention, a system useful for storing and dispensing a potable liquid from a bottle having a neck comprises a cabinet having an inclined surface and at least one opening configured and arranged to receive the neck of a bottle, a gas source of inert, non-oxygen containing gas, a pressure regulator in fluid communication with said gas source, a gas line in fluid communication with the pressure regulator, at least one bottle head configured and arranged to form a fluid seal when positioned in the neck of the bottle, the at least one bottle head including a gas passage and a fluid passage, wherein the gas line is in fluid communication with the gas passage of the at least one bottle head.

Still other aspects, features, and attendant advantages of the present invention will become apparent to those skilled in the art from a reading of the following detailed description of embodiments constructed in accordance therewith, taken in conjunction with the accompanying drawings.

### BRIEF DESCRIPTION OF THE DRAWINGS

The invention of the present application will now be described in more detail with reference to exemplary embodiments of the apparatus and method, given only by way of example, and with reference to the accompanying drawings, in which:

FIG. 1a illustrates a front elevational view of an exemplary embodiment of a potable liquid preservation and dispensing system in accordance with principles of the present invention.

FIG. 1b illustrates a side elevational view of the system of FIG. 1a.

FIG. 2 illustrates portions of the system of FIG. 1a.

FIG. 3a illustrates top plan view of portions of the system of FIG. 1a.

FIG. 3b illustrates a front elevational view of portions of the system of FIG. 1a.

FIG. 4a illustrates an enlarged elevational view of an exemplary head of the system of FIG. 1a.

FIG. 4b illustrates the head of FIG. 4a in a second configuration.

FIG. 4c illustrates portions of the head of FIG. 4a.

FIG. 4d illustrates a top plan view of an exemplary force transmission unit in accordance with principles of the present invention.

FIG. 4e illustrates a side elevational view of the unit of FIG. 4d.

### DETAILED DESCRIPTION OF EXEMPLARY EMBODIMENTS

Referring to the drawing figures, like reference numerals designate identical or corresponding elements throughout the several figures.

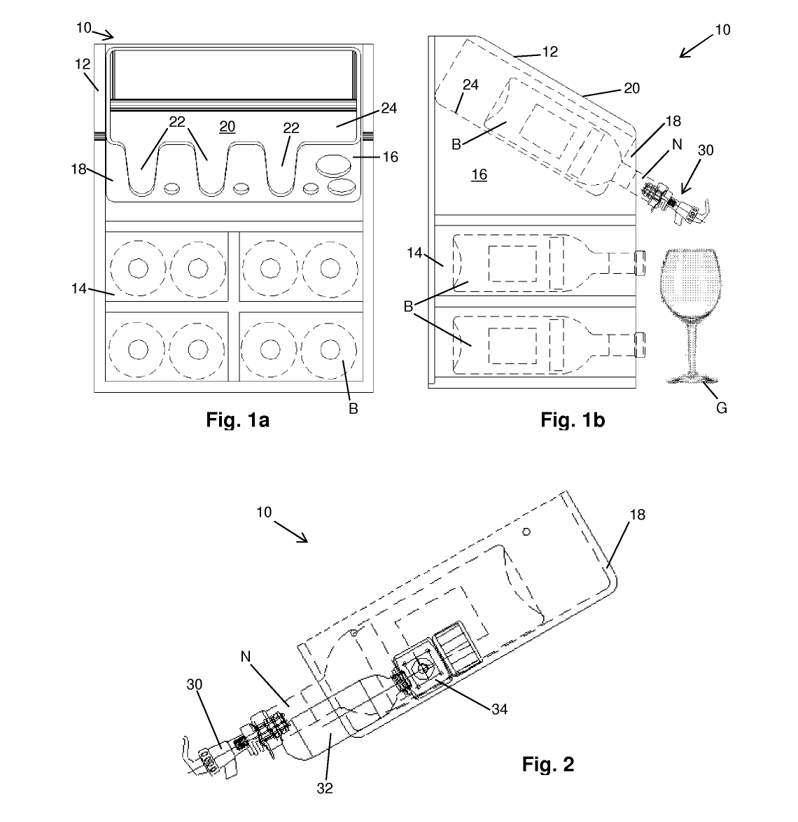

FIG. 1 illustrates front (FIG. 1a) and side (FIG. 1b) elevational views of a storage and dispensing system 10 embodying principles of the present invention. A cabinet 12 is illustrated having a bottom storage area 14 including, by way of non-limiting example, four compartments that are sized and configured to hold one or more (eight are illustrated) containers of a potable liquid. Without being limited to any single potable liquid, some aspects of the present invention, as described in greater detail below, are particularly advantageous when the potable liquid is wine and the containers are bottles B, e.g., glass bottles, e.g., 750 ml wine bottles.

A top portion 16 of the cabinet 12 includes a positioning and dispensing tray 18, which has a generally open top 20 and one or more slots 22. The slots are sized to accept the neck of a typical 750 ml glass wine bottle, although other sizes, selected to similarly accommodate other sized liquid containers, may alternatively be provided. The top portion 16 includes a slanted support surface 24 so that one or more bottles of liquid can be supported with the neck N of the bottle B in a slot, so that the potable liquid contents of the bottle can flow out of the bottle by gravity. Preferably the bottle B, and optionally each bottle, that is supported in the top portion 16 of the cabinet 12 includes a dispensing head 30, such as that illustrated, which seals the neck of the bottle and permits a user of the system to selectively dispense the potable liquid from the bottle into, e.g., a glass G.

FIG. 2 illustrates a right side elevational view of a portion of the system 10. The bottle head 30 is installed in the bottle neck N, as described above. A compressed gas cylinder 32 is provided in a separate space in the cabinet, and includes a pressure regulator 34. The gas in the cylinder is a food grade inert gas that does not significantly react with the potable liquid in the container(s); when the potable liquid is wine or another liquid that is negatively affected by prolonged contact with oxygen, the inert gas is preferably nitrogen. As described in greater detail below, the inert gas cylinder 32 is in fluid communication, via the pressure regulator 34, with the dispensing head 30 to slightly pressurize the contents of the container, and more advantageously to sparge air (and other gases) from the container and replace it with the inert gas. In this manner, the potable liquid contents of the container are at least partially preserved, despite the fact that the container's original closure (e.g., a cork or screw cap) has been removed and air had been allowed to fill the dead space in the container, because the inert gas blankets the potable liquid and inhibits or prevents contact with other gases (such as oxygen). One of numerous commercially available regulators usable as regulator 34 is model NR-30 by Nippon Transan Gas Co. LTD, through its US affiliate, Leland Limited (South Plainfield, N.J.); others are also available and usable. Several of numerous commercially available inert gas cylinders usable as cylinder 32 are available from Nippon Transan Gas Co. LTD, in their Mini Gas Cartridge line, including the LPG-type cylinder (also available through Leland); other suitable containers are available from NitroTap, LTD (Warren, R.I.).

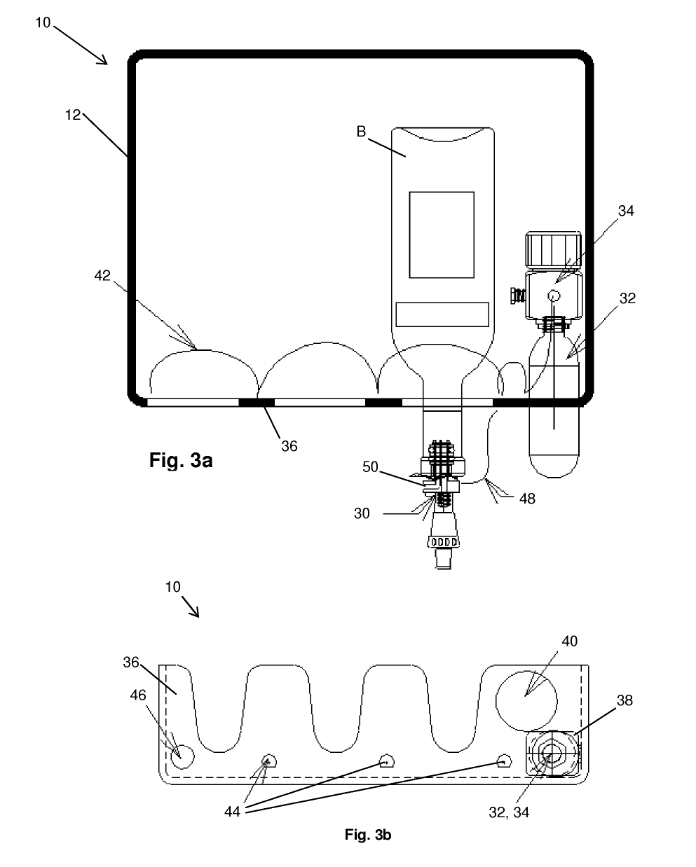

FIG. 3 illustrates top plan (FIG. 3a) and partial front elevational (FIG. 3b) views of an exemplary system 10 in accordance with the present invention. The top portion 16, including the inclined bottle tray 18, is illustrated supporting a single wine bottle B and the compressed gas cylinder 32 and the pressure regulator 34 attached to the cylinder. The front face 36 of the top portion 16 preferably includes a cutout or hole 38 through which the base of the cylinder 32 can extend, for easy access and removal, and a pressure gauge 40, in fluid communication with the pressure regulator, which displays the fluid pressure output by the regulator. A gas distribution tube, manifold, or the like 42 fluidly connects the output of the pressure regulator 34, the pressure gauge 40, one or more self-sealing fluid connection ports 44 that are positioned on the front face 36 of the cabinet, and preferably a pressure relief valve 46 positioned at a convenient location on the cabinet. One or more gas injection tubes 48, preferably flexible, lead from the one or more connection ports 44 to an input port 50 on the head 30. The port 50 is, when the head 30 is installed in a suitable neck N, in fluid communication with the interior of the bottle via a separate fluid passage 72.

Another advantageous aspect of the present invention includes that the connections between the head(s) 30 and the connection port(s) 44 are optionally self-sealing. Thus, when the tube 48 is connected to the port 44 and the input 50 to the head 30, inert gas flows from the distribution tube 42, through the port 44, through the tube 48, through the head 30 via passage 72, and into the container B holding the potable liquid. Importantly, each of the portions of the system outside of the cabinet at which this sealed fluid connection can be broken by the user of the system, includes a self-sealing valve or connection element. For example, such a self-sealing element can be located in one or more of: in the head 30; at the end of the tube 48 which connects to the head 30; at the end of the tube 48 that connects to the port 44; and at the port 44. In one non-limiting example, the tube 48 is securely connected to the head 30, and the port 44 and the opposite end of the tube 48 each include self-sealing elements. In another non-limiting example, the tube 48 is securely connected to the port 44, and the head 30 and the opposite end of the tube 48 each include self-sealing elements.

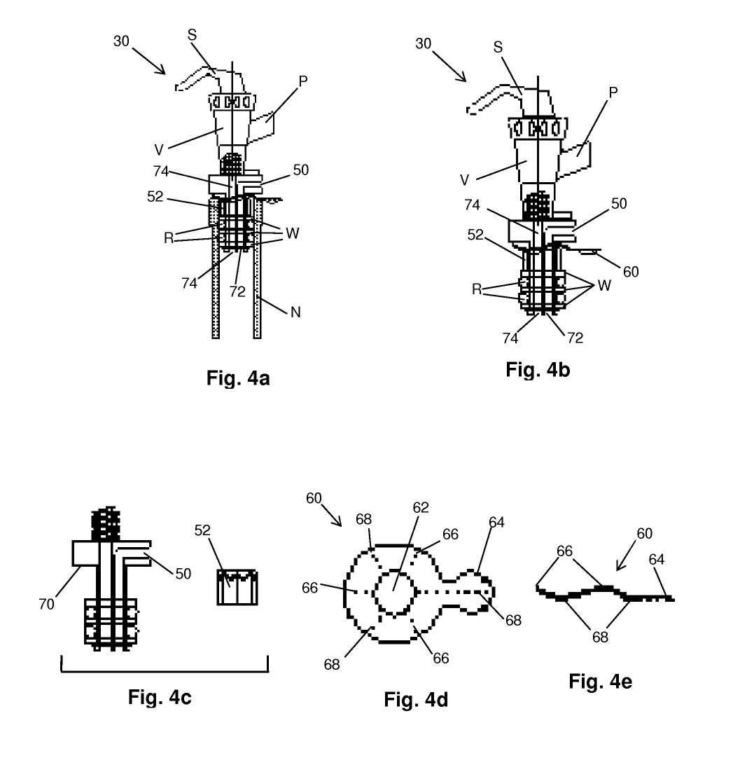

FIG. 4 (including FIGS. 4a-4e) illustrates several views of an exemplary bottle head 30 embodying principles of the present invention. The head 30 is sized to fit into and selectively seal against the inner surface of the potable liquid's container, e.g., wine bottle neck N. The head includes a valve V, valve stem S, and liquid outlet port P of conventional constructions, the details of which are well known to those of ordinary skill in the art and are thus not included herein so as to not obscure the invention; one example of these elements is a so-called Tomlinson brand model CBT #1000004 Tap. As well known to those of skill in the art, the outlet port P is in fluid communication with a fluid passage 74 which extends through the head, which is separate from the gas passage 72. The lower portions of the head, which are shown positioned in the neck of the bottle, includes one or more compression seals, gaskets, or O-rings R which, when compressed, expand outward and form a seal between the head 30 and the interior surface of the bottle neck N, in a known manner. The head therefore includes a number of washers W or similar elements between which the O-rings are positioned, and the bottommost of which is fixed relative to the rest of the head. A sleeve or ferrule 52 is positioned above the topmost washer and can slide relative to the rest of the head. By moving the head 30 relative to the sleeve 52, the sleeve pushes down on the topmost washer, which in turn pushes down on and compresses the adjacent O-ring, on down to the washer which is fixed to the head. Thus, moving the top and bottommost parts of the head compresses the O-rings and causes them to seal against the inner surface of the bottle neck N.

One advantageous aspect of the present invention, which facilitates moving the parts of the head and thus sealing the head in the bottle neck, includes providing a force transmission unit which is accessible to a user of the head and which converts rotary motion of and force on the unit into a downward motion, and therefore force, by the unit. In general terms, the force transmission unit can be embodied in one of numerous devices which operate based on the well-known “inclined plane” configuration, such as screw threads, wedges, cams, including rotary cams, and the like, any of which exert downward motion and force. This downward motion and force is used, in the context of the present invention, for the compression and lateral expansion of the seals described above.

According to a preferred, yet still exemplary, embodiment, the force transmission unit includes one or a pair of wave washers 60, illustrated in FIGS. 4d and 4e. Each wave washer 60 is generally disk-shaped with a center opening 62 sized to receive corresponding portions of the head 30 therein, but in profile has an undulating shape and includes a lever 64 that projects outward from the disk. More specifically, each wave washer 60 includes high portions 66 and low portions 68 therebetween. While the number of undulations does not restrict the present invention, a small number is preferable to reduce the force required to use the wave washers. As illustrated in FIGS. 4a and 4b, two wave washers 60 are positioned around the middle of the head 30, above the sleeve 52, with the washers' levers 64 adjacent to, but preferably not overlapping, each other, and the washers' undulations 66, 68 mated together; in this configuration, the two wave washers have a thin profile. An expanded profile of the two wave washers 60 is achieved by rotating one of the wave washers relative to the other (clearly, both washers can be simultaneously rotated) around the longitudinal (up-down) axis of the head 30, which causes the adjoining surfaces of the two wave washers to slide against each other toward an anti-nested orientation, in which upward extending undulations 66 of the lower washer are vertically aligned with and touch downward extending undulations 68 of the upper washer, and vice versa. Thus, when the wave washers 60 are rotated the distance of one undulation, the washers move apart (or toward) each other the height of one of the wave washers, pushing on the adjacent portions of the head 30 as described above.

Yet another aspect of the present invention includes that the profile of a wave washer 60 is formed on a portion of the head 30, e.g., the top of the sleeve 52 or the bottom of the adjoining upper portion 70 of the head, and only one rotatable wave washer 60 is positioned adjacent thereto.

The two wave washers 60, positioned between the top portion of the head 30 and the top of the sleeve 52, thus can be used to quickly move the sleeve down relative to the rest of the head, and thus expand the O-rings R against the bottle neck N. The present invention is not limited to the use of wave washers 60, however, and more conventional force-fit compression fittings, with typical flexible fins, a cam-style lever, and screw thread-and-nut configurations are also alternatively used.

One advantage of the present system is that it does not require refrigeration to preserve the potable liquid in the container. According to other aspects of the present invention, the cabinet 12 can be constructed to include a coolant system that cools the containers, in a known manner. Further optionally, the system can be sized and configured to be positioned inside a refrigerator.

A particularly advantageous aspect of the present invention includes that the individual containers can be removed from the system, e.g., in order to dispense a different liquid, without releasing the inert gas from inside the container. An exemplary method of using the system thus includes: positioning a container having a potable liquid, e.g., wine, therein, in the top portion of the cabinet 12; attaching tube 48 to the inlet port 50 of the head 30, thus fluidly connecting the interior of the container with the inert gas cylinder 32 via the pressure regulator 34, the distribution line 42, and the port 44; dispensing potable liquid from the container by manipulating the valve V contained in the head 30, in a known manner; disconnecting the tube 48 from the head 30 and/or from the port 44; and removing the container B from the cabinet 12, now that it is no longer tethered to the cabinet by the tube 48. Because the head 30, tube 48, and/or port 44 each includes a self-sealing element, the inert gas does not escape from the container, the potable liquid is continuously preserved, and a vacuum is not created in the container when liquid is dispensed. A system of the present invention can therefore include more potable liquid containers than can be supported in the top portion of the cabinet, each container fitted with a head 30, and the containers can be merely swapped out of the cabinet when it is desired to more easily dispense the liquid. Each head 30 thus ‘belongs’ to a container, sealing the container and preserving its potable liquid contents.

Another advantageous aspect of the present invention includes that open, serviceable wine bottles B are stored in a relatively horizontal position, which compresses their ordinary storage height by about 50%, compared to upright (standing) storage of a wine bottle. This facilitates use and storage of open wine bottles in smaller spaces, such as pullout drawers in conventional kitchen cabinetry, refrigerators, and even specially-constructed sideboard chests. Thus, a slightly neck-down orientation of containers of potable liquids, a ‘ready to dispense’ configuration, is unique and affords many benefits.

The self-sealing elements described herein are currently commercially available; examples include, but are not limited to: Beswick Engineering Quick Disconnect Couplings QDC-101-I-1012 and QDC-101-E-2PM (Double Shut-off), and Colder Products Couplings PMCD12025 and PMCD2202 (Valved Shutoff).

Another advantageous aspect of the present invention includes that the pressure regulator 34 maintains the pressure in the system at a low level, e.g., between about 3 and 7 psi, preferably about 5 psi. While this pressure is sufficient to charge the system with inert gas, it differs from typical dispensing systems which use a vertically oriented potable liquid container, a siphon tube in the container, and gas pressures typically around 30 psi. In the system of the present invention, a high gas pressure in the system would result in the liquid contents of the container being sprayed out of the outlet P of the head 30, and would require a significantly more robust pressure vessel for the insert gas cylinder 3; both of these would be significantly less preferred. Pressure regulators capable of maintaining pressure in the system at about 5 psi are currently commercially available and well known to those of ordinary skill in the art.

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

What is claimed is:

1. A wave washer comprising:
a disk;
an opening in the disk;
a lever extending from the disk; and
undulations formed in the disk.

2. A wave washer according to claim 1, wherein the undulations include upward and downward undulations.

3. A wave washer according to claim 2, wherein there are equal numbers of upward and downward undulations.

4. A wave washer according to claim 1, wherein the undulations are configured and arranged so that when two such wave washers are positioned one atop the other, the wave washers' respective undulations nest.

5. A bottle head comprising:
a valve having a valve stem, a fluid passage, and a dispensing port in fluid communication with the fluid passage;
a seal portion extending from said valve, the fluid passage passing through the seal portion;
at least one seal positioned around the seal portion;
a movable element on the seal portion and adjacent to the at the least one seal; and
at least one wave washer in accordance with claim 1 positioned on said seal portion between said movable element and said valve.

6. A bottle head according to claim 5, wherein the at least one wave washer comprises two wave washers positioned adjacent to each other on said seal portion between said movable element and said valve.

7. A bottle head according to claim 5, further comprising:
a gas passage extending through the seal portion and separate from the fluid passage, the gas passage including a gas inlet port.

8. A bottle head according to claim 7, further comprising a self-sealing element in said gas passage.

9. A system useful for storing and dispensing a potable liquid from a bottle having a neck, the system comprising:
a cabinet having an inclined surface and at least one opening configured and arranged to receive the neck of a bottle;
a gas source of inert, non-oxygen containing gas;
a pressure regulator in fluid communication with said gas source;
a gas line in fluid communication with the pressure regulator;
at least one bottle head configured and arranged to form a fluid seal when positioned in the neck of the bottle, the at least one bottle head including a gas passage and a fluid passage;
wherein the gas line is in fluid communication with the gas passage of the at least one bottle head.

10. A system according to claim 9, further comprising:
a bottle of wine in said cabinet and resting on the inclined surface, the bottle having a neck received in the at least one opening, the at least one bottle head positioned partially in and sealing the bottle neck.

11. A system according to claim 9, further comprising:
a self sealing element in the gas line, in the bottle head gas passage, or in both.

12. A system according to claim 9, further comprising:
at least one gas port positioned on said cabinet;
at least one bottle head gas line fluidly communicating the gas passage of each at least one head with the at least one gas port;
wherein the gas line fluidly connects between the pressure regulator and the at least one gas port.

13. A system according to claim 12, further comprising:
at least one self sealing element in the at least one gas port, in the gas passage of the at least one bottle head, or in both.

14. A system according to claim 12, wherein:
the at least one gas port comprises a plurality of gas ports, the gas line fluidly connected between the pressure regulator and the plurality of gas ports; and
the at least one opening comprises a plurality of openings configured and arranged to each receive the neck of a bottle.

15. A system according to claim 9, further comprising:
a gas vent in fluid communication with the gas line.

16. A system according to claim 9, wherein the cabinet further comprises a lower section configured and arranged to contain a plurality of wine bottles.

17. A system according to claim 9, wherein the at least one bottle head further comprises:
a valve having a valve stem and a dispensing port in fluid communication with the fluid passage;
a seal portion extending from said valve, the fluid passage passing through the seal portion;
at least one seal positioned around the seal portion;
a movable element on the seal portion and adjacent to the at the least one seal; and
at least one wave washer positioned on said seal portion between said movable element and said valve, the wave washer including
a disk,
an opening in the disk,
a lever extending from the disk, and
undulations formed in the disk.

18. A method of storing and dispensing wine, the method comprising:
positioning a bottle head in the neck of a bottle containing the wine;
resting the wine bottle on an incline with the bottle head down;
fluidly connecting a source of inert, non-oxygen-containing gas with the interior of the bottle; and
dispensing wine from the bottle.

19. A method according to claim 18, wherein the wine bottle is a first wine bottle and the bottle head is a first bottle head, and further comprising:
providing a self sealing element in the first bottle head, or in a gas line fluidly connecting the first bottle head with the gas source, or in both;
disconnecting the first bottle head from the gas source;
fluidly connecting a second bottle having a neck, containing wine, and including a second bottle head positioned in the neck of the second bottle, to the gas source; and
resting the second wine bottle on an incline with the second bottle head down.

20. A method according to claim 19, wherein resting the second wine bottle on an incline comprises resting the second bottle adjacent to the first bottle, both the first bottle and the second bottle being at an incline with the bottle head of each down.
